(19) United States
(12) Patent Application Publication
(10) Pub. No.: US 2014/0220290 A1
(43) Pub. Date: Aug. 7, 2014

(54) DISK FOR FABRICATING GRAPHENE AND METHOD OF MANUFACTURING THE SAME

(71) Applicants: SEOUL NATIONAL UNIVERSITY R&DB FOUNDATION, Seoul (KR); TOSHIBA SAMSUNG STORAGE TECHNOLOGY KOREA CORPORATION, Suwon-si (KR)

(72) Inventors: Kil-Soo Choi, Seoul (KR); Byung-Youn Song, Suwon-si (KR); Nag-Eui Choi, Suwon-si (KR); Hyoung-Sub Shim, Seoul (KR); Han-Yung Jung, Seoul (KR); Jung-Hoon Lee, Seoul (KR)

(73) Assignees: TOSHIBA SAMSUNG STORAGE TECHNOLOGY KOREA CORPORATION, Suwon-si (KR); SEOUL NATIONAL UNIVERSITY R&DB FOUNDATION, Seoul (KR)

(21) Appl. No.: 14/055,000

(22) Filed: Oct. 16, 2013

(30) Foreign Application Priority Data
Feb. 5, 2013 (KR) 10-2013-0013045

(51) Int. Cl. C01B 31/04

(52) U.S. Cl. CPC C01B 31/0446
USPC 428/64.1; 428/688; 428/412; 427/162

(57) ABSTRACT

A disk used for fabricating graphene, a multilayered plate, and a method of manufacturing the same are provided. The disk includes a thermoplastic polymer substrate with a reflection layer disposed on one side of the thermoplastic polymer substrate; and a graphite oxide layer provided on the thermoplastic polymer substrate. The method of manufacturing a disk for fabricating graphene involves: obtaining a thermoplastic polymer substrate with a reflection layer disposed on one side thereof; and applying a graphite oxide layer on the thermoplastic polymer substrate.

### CROSS-REFERENCE TO RELATED APPLICATION

This application claims the benefit under 35 U.S.C. §119(a) of Korean Patent Application No. 10-2013-0013045, filed on Feb. 5, 2013, in the Korean Intellectual Property Office, the entire disclosure of which is incorporated herein by reference for all purposes.

### BACKGROUND

1. Field

The following description relates to a disk or a multilayered plate for fabricating graphene and a method of producing the same, such as, for example, an optical disk for fabricating graphene, and a method of producing such an optical disk using an optical recording and/or reproducing device.

2. Description of Related Art

Graphene is an allotrope of carbon, consisting of a single two-dimensional planar sheet of carbon atoms with a thickness of about 0.35 nanometers. In a graphene sheet, carbon atoms are packed into a honeycomb lattice, forming free spaces therebetween. The arrangement of carbon atoms and free spaces therebetween provide a graphene sheet with flexibility that allows a certain degree of deformation, such as bending and twisting. In addition, a hexagonal arrangement of carbon atoms ensures electrical conductivity and chemical stability.

Graphene can carry two hundred times more current than copper and can carry current two hundred times faster than silicon at a room temperature. In addition, graphene has twice the room-temperature thermal conductivity than diamond, and two hundred times more mechanical strength than steel. Therefore, researches for utilizing graphene, as one of the most promising future electronic materials, are increasing. Due to such excellent properties, for example, an electrode made of graphene may have both high energy density of a battery and high power performance of a capacitor.

Graphene is generally obtained by an exfoliation method or a synthesis method. In an exfoliation method, a graphene layer may be exfoliated from graphite. Graphite is abundantly present in nature. Further, in comparison to a synthesis method, the exfoliation method is characterized by low energy consumption, and enables mass production of graphene. However, with the exfoliation method, it is difficult to achieve a graphene sheet having a large surface area, and the yield is generally low in comparison to the amount of graphite that is processed. The exfoliation method may be further classified into a physical exfoliation method and a chemical exfoliation method, depending on the treatment method used for exfoliation.

A synthesis method synthesizes a layer of graphene directly from a carbon source. In comparison to the exfoliation method, the synthesis method requires more energy. However, the synthesis method enables production of graphene sheets having a large surface area with low defects.

However, with the above described methods, limitations exist in effectively forming graphene sheets having a large surface area and excellent uniformity in the molecular arrangement of carbon atoms. For instance, the actual capacitance per unit weight exhibited by the graphene sheets formed by a general method is 99 to 130 F/g, which is much lower than the highest theoretical capacitance value, 550 F/g.

### SUMMARY

In one general aspect, there is provided a disk used for fabricating graphene, the disk including: a thermoplastic polymer substrate with a reflection layer disposed on one side of the thermoplastic polymer substrate; and a graphite oxide layer provided on the thermoplastic polymer substrate.

The disk may further include a separation coating layer disposed between the thermoplastic polymer substrate and the graphite oxide layer.

The disk may further include a protection layer disposed above the reflection layer.

The thermoplastic polymer substrate may include a polycarbonate substrate.

In another general aspect, there is provided a multilayered plate for fabricating graphene, the multilayered plate including: a substrate; a reflection layer formed on the substrate; and a graphite oxide layer formed on the reflection layer.

The multilayered plate may have a shape of a circular optical disk with a central hole.

The multilayered plate may have a rectangular shape or a polygonal shape.

The substrate may include a polycarbonate layer, and the substrate may have a diameter of 11 cm to 13 cm with a planar upper surface.

The multilayered plate may further include: a protective layer disposed between the reflection layer and the graphite oxide layer; and a separation coating layer disposed between the protective layer and the graphite oxide layer.

In another general aspect, there is provided a method of manufacturing a disk for fabricating graphene, the method involving: obtaining a thermoplastic polymer substrate with a reflection layer disposed on one side thereof; and applying a graphite oxide layer on the thermoplastic polymer substrate.

The method may further involve: prior to the applying of the thin film of graphite oxide layer, applying a separation coating layer between the thermoplastic polymer substrate and the graphite oxide layer.

The thermoplastic polymer substrate may include a protection layer disposed above the reflection layer to protect the reflection layer.

The thermoplastic polymer substrate may include a polycarbonate substrate.

The applying of the graphite oxide layer may involve applying a graphite oxide solution formed by mixing graphite powder with a solvent.

Other features and aspects will be apparent from the following detailed description, the drawings, and the claims.

### BRIEF DESCRIPTION OF THE DRAWINGS

FIG. 1 is a diagram illustrating an example of a disk with a separation coating layer for fabricating graphene.

FIG. 2 is a diagram illustrating another example of a disk with a separation coating layer for fabricating graphene.

FIG. 3 is a diagram illustrating an example of a disk without a separation coating layer for fabricating graphene.

FIG. 4 is a diagram illustrating another example of a disk without a separation coating layer for fabricating graphene.

FIG. 5(a)-(d) is a perspective view of additional examples of a disk or a multilayered plate for fabricating graphene.

FIG. 6 is a plan view of another example of a disk for fabricating graphene.

FIG. 7 is a flowchart illustrating an example of a method of manufacturing a disk used for fabricating graphene.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

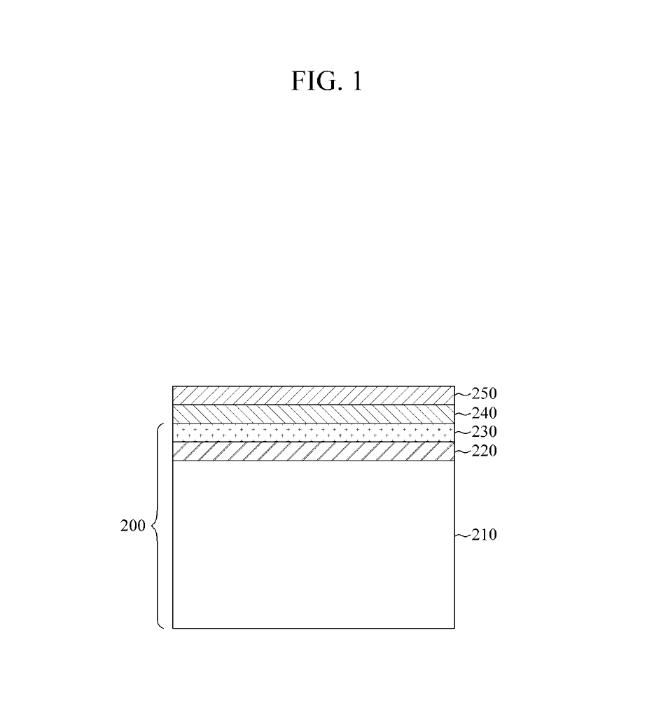

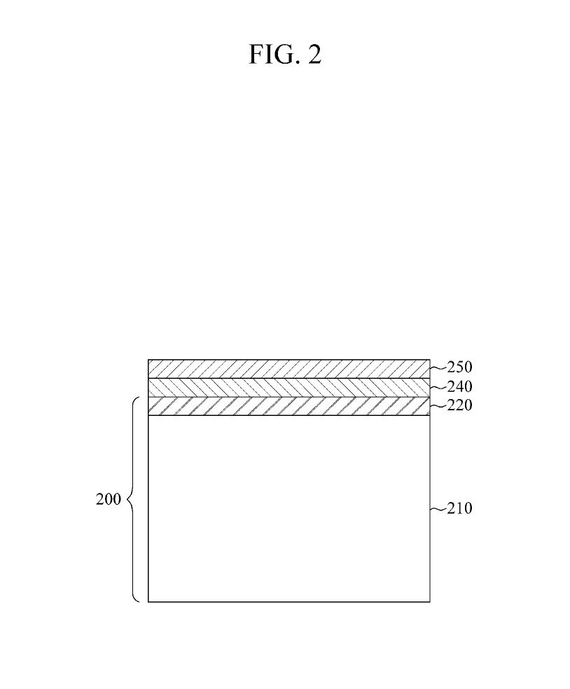

FIGS. 1 and 2 are diagrams illustrating examples of disks with a separation coating layer for fabricating graphene. The disk may be formed from an optical disk.

Referring to FIGS. 1 and 2, a disk with a separation coating layer embedded therein used for fabricating graphene may include a thermoplastic polymer substrate 200 and a graphite oxide layer 250 applied on the thermoplastic polymer substrate 200. The optical disk may further include a separation coating layer 240 interposed to separate the graphite oxide layer 250 and the thermoplastic polymer substrate 200. In this example, the separation coating layer 240 may be made of a high molecular resin composition, such as PET. In another example, a surfactant applied onto the thermoplastic polymer substrate 200 may be used as the separation coating layer 240. However, its material is not limited thereto.

The thermoplastic polymer substrate 200 may include a reflection layer 220 on one surface so as to reflect incident light. For example, the thermoplastic polymer substrate 200 may include a lower substrate 210, a reflection layer 220 above the lower substrate 210, and a protective layer 230 disposed above the reflection layer 220 to protect the reflection layer 220. However, the optical disk illustrated in FIG. 1 is provided only as an example, and a disk having less than all of the described layers are within the scope of the present disclosure. For example, as shown in FIG. 2, the thermoplastic polymer substrate 200 may only include the lower substrate 210 and the reflection layer 220 without the protection layer 230.

The thermoplastic plastic polymer substrate 200 may be a polycarbonate substrate. Polycarbonate, as a member of a particular thermoplastic polymer group, is capable of being easily manipulated, injection-molded and thermoformed. Polycarbonate is multifunctional engineering plastic with excellent heat-resistance, impact resistance, and optical properties, thereby being widely used for product plastic and engineering plastic and also as a material for exteriors of information electronics, such as, mobile phones, notebook computers, and monitors, and optical storage media, such as CDs and DVDs.

Although polycarbonate is used in this example as the polymer material for forming the thermal polymer substrate 200, the substrate 200 may be made of different types of materials, including other polymers or composite materials.

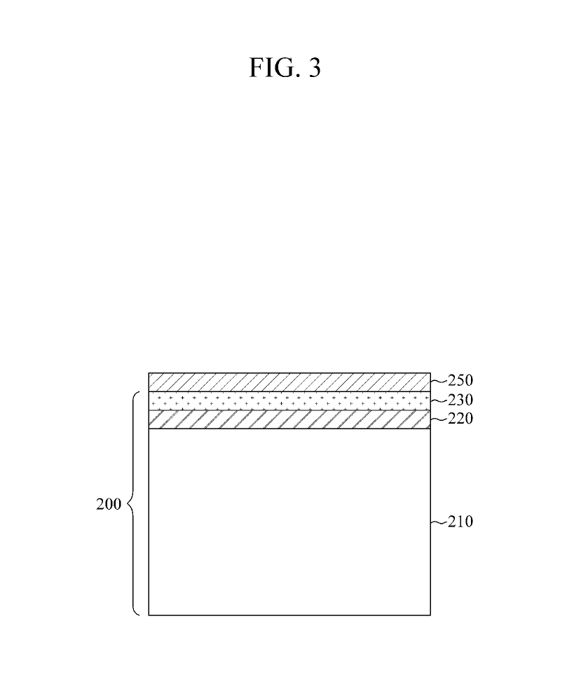

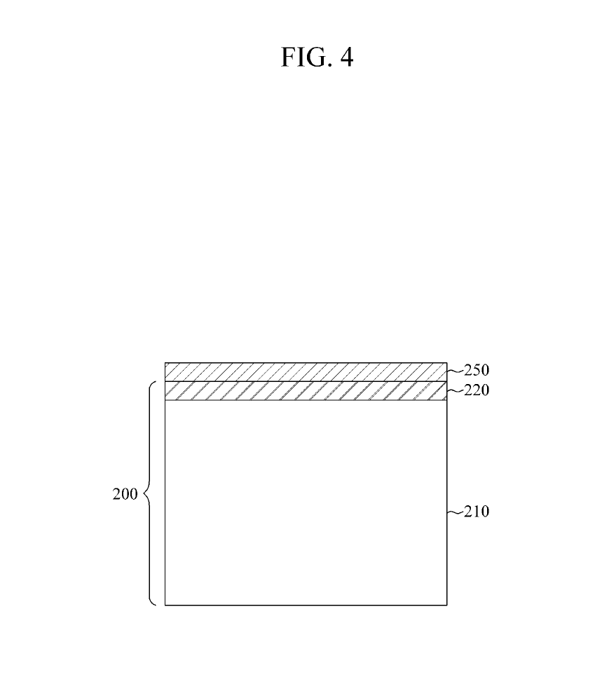

FIGS. 3 and 4 are diagrams illustrating another example of a disk for fabricating graphene. The disk may be formed from an optical disk without a separation coating layer.

As shown in FIGS. 3 and 4, unlike the disks illustrated in FIGS. 1 and 2, the disks used for fabricating graphene illustrated in FIGS. 3 and 4 do not include a separation coating layer 240. The disks shown in FIGS. 3 and 4 only include a thermoplastic polymer substrate 200 and a graphite oxide layer 250 because a layer of reduced graphite oxide can be used without being separated from the thermoplastic polymer substrate 200.

The disks illustrated in FIGS. 1 to 4 may be constructed to have a structure similar to a general DVD, excluding the separation coating layer 240 and the graphite oxide layer 250. However, the disk for fabricating graphene of the present disclosure is not limited thereto. The shape, size and arrangement of the layers, and the materials for forming the layers, may be different in other examples.

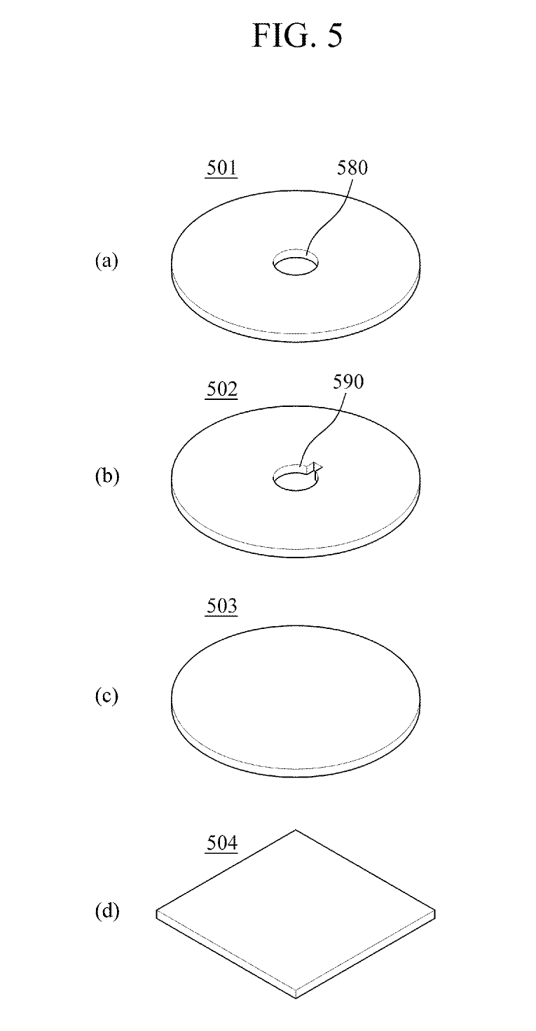

FIG. 5(a)-(d) illustrate additional examples of disks and multilayered plates that may be used to fabricate graphene. FIG. 5(a) illustrates an example of a disk 501 having a central hole, like that of an optical disk such as CDs and DVDs. The shape and dimension of the disk 501 may be similar to that of a standard CDs and DVDs, for example. The disk 501 may be a multilayered plate having a layer arrangement shown in FIGS. 1-4, with a graphite oxide layer 250 arranged as the top layer of the plate. As an example, the thermoplastic polymer substrate 100 of the disk 501 may have a diameter in a range of 6 cm to 30 cm, or 11 cm to 13 cm. In one example, the thermoplastic polymer substrate 100 of the disk 501 has a diameter of approximately 12 cm. However, the dimension or the shape of the disk is not limited thereto, and may vary widely.

FIGS. 5(b) and 5(c) illustrate additional examples of disks 502, 503 that may be used to fabricate graphene. The arrangement of layers within the disks 502, 503 may be the same as the examples of disks illustrated in FIGS. 1-4. The disks 502, 503 may be an optical disk formed from a standard DVD or CD. The disk 502 illustrated in FIG. 5(b) include a notch along a central hole to facilitate the rotation of the disk. Notches can be provided on different positions of the disk to facilitate the rotation of the disk. Other shapes of disks with a different external shape that allows rotation in a standard optical recording or reproducing device are within the scope of the present disclosure. In addition, as illustrated in FIG. 5(c), the disk 503 may have a planar upper surface without a central hole. Nevertheless, the disk 503 may be configured to be rotated by a rotating device through a latch on the bottom surface of the disk 503. Further, as illustrated in FIG. 5(d), the disk 504 may be a multilayered plate that is not circular in shape. For example, the disk may have an oval shape, an elliptical shape, a rectangular shape, or a polygonal shape. The disk may have a hole or a notch in the center or in the periphery to facilitate rotation or transportation of the disk. The disk may have a planar portion on its upper surface, but may also include protrusions or notches.

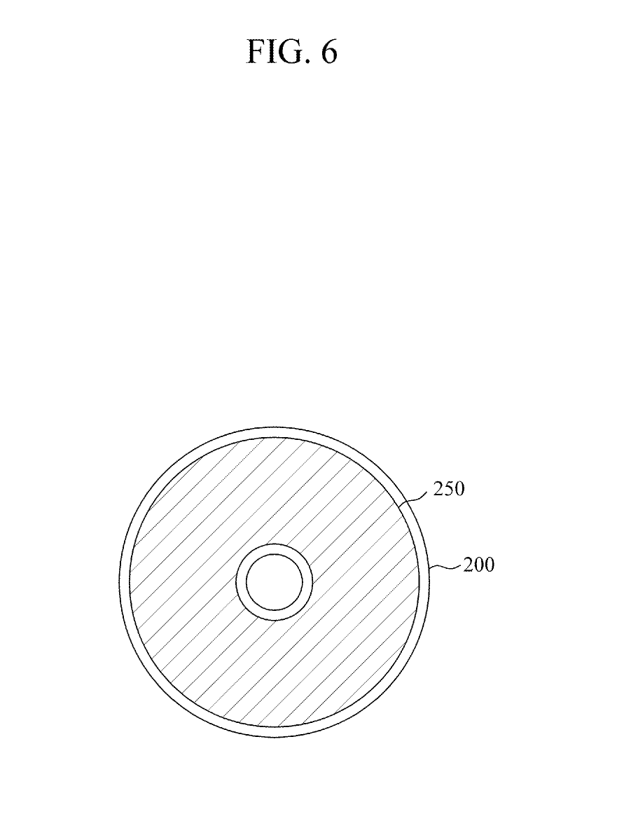

FIG. 6 illustrates a plan view of another example of a disk for fabricating graphene. The illustrated disk may be formed from an optical disk. The disk illustrated in FIG. 6 may have an internal arrangement of a lower substrate 210, a reflection layer 220, a protective layer 230, and a separation coating layer 240 as shown in FIGS. 1-4, and the graphite oxide layer 250 may be applied over either an entire surface of the disk or over a portion of the disk. In the example illustrated in FIG. 6, the graphite oxide layer 250 is formed only on an inner portion of the disk. The separation coating layer 240 likewise may be formed over an entire surface of the thermoplastic polymer substrate 200 or only under a portion where the graphite oxide layer 250 is applied.

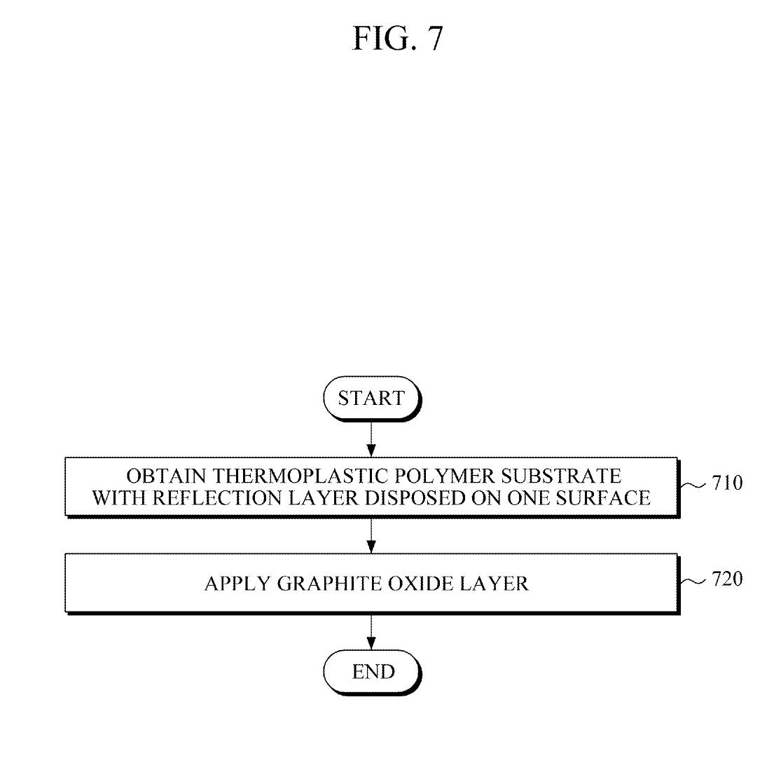

FIG. 7 is a flowchart illustrating an example of a method of fabricating an optical disk used for fabricating graphene.

First, a thermoplastic polymer substrate with a reflection surface disposed on one side for reflecting incident light is obtained in 710. Then, a thin film layer of graphite oxide (GO) is applied on the thermoplastic polymer substrate in 720. The thermoplastic polymer substrate with the reflection surface may be a standard optical disk or a disk formed by laminating a thermoplastic polymer substrate with a thin reflective layer.

The thin film layer of GO may be formed on the thermoplastic polymer substrate by dropping droplets of a GO solution onto the thermoplastic polymer substrate while the thermoplastic substrate is being rotated by an optical disk recording and/or reproducing device. This method may be referred to as a drop-casting method. In the alternative, the thin film layer of GO may be formed using vacuum filtering GO dispersion method while an optical disk recording and/or reproducing device is turning the thermoplastic polymer substrate.

To make a GO solution, graphite powder with high purity is first fabricated using modified a Hummers method or the like. The resulting powder is dispersed into water by an ultrasonic treatment, uniformly distributing the graphite oxide in the water to obtain a homogenous mixture. The uniform mixture may be used as the GO solution. For example, the graphite powder may be dispersed at a density of 3.7 mg/ml with an ultrasonic treatment or other dispersion method. The resulting GO solution is dropped or applied to the substrate. Examples of methods of applying the GO solution to the thermoplastic polymer substrate may include the drop-casting method or the vacuum filtering GO dispersion method, as described above. In this example, after applying the GO solution to the substrate, the substrate is air dried for 24 hours.

Prior to the application of the GO layer in operation 720, a separation coating layer may be further applied on the thermoplastic polymer substrate before the GO layer in order to separate the GO layer from the thermoplastic polymer substrate. The separation coating may include a thin plastic film, such as a PET film. The PET film may be laminated on the thermoplastic polymer substrate, the protective layer or the reflection layer before the thermoplastic polymer substrate is placed on an optical disk recording and/or reproducing device. In the alternative, the separation coating layer may be formed by applying a surfactant over an upper surface of the thermoplastic polymer substrate, the protective layer or the reflective layer. However, the method of forming the separation coating layer is not limited thereto.

While an optical disk recording and/or reproducing device is used in this example, any other mechanical device that rotates or moves the disk or multilayered plate can be used to apply the GO layer or separation coating layer on the thermoplastic polymer substrate. Further, in other examples, the GO layer or separation coating layer may be applied while the application device moves above a fixed thermoplastic polymer substrate.

Described above are examples of a disk used for fabricating graphene, the disk including: a thermoplastic polymer substrate with a reflection layer disposed on one surface for reflecting incident light; and a thin-film of graphite oxide layer applied onto the thermoplastic polymer substrate. The disk may further comprise a separation coating layer interposed between the thermoplastic polymer substrate and the graphite oxide layer so as to separate them. The optical disk may further comprise a protection layer disposed above the reflection layer to protect the reflection layer. The thermoplastic polymer substrate may be a polycarbonate substrate. Also described above are examples of methods of manufacturing a disk used for fabricating graphene, the method involving: preparing a thermoplastic polymer substrate with a reflection layer disposed on one surface for reflecting incident light; and applying a thin film of graphite oxide layer on the thermoplastic polymer substrate.

As described above, the thermoplastic polymer substrate may be a polycarbonate substrate, and may have a structure similar to that of a general DVD or CD. In some examples, a general DVD or CD are used as the thermoplastic polymer substrate. In other examples, the thermoplastic polymer substrate may have a greater thickness or a large dimension than that of a general DVD or CD. The various layers of the multilayered plate that forms the disk may also have different thicknesses.

According to the above described examples, mass production of high-quality graphene is possible at a low cost by using a structure of a general optical disk. In addition, graphene made according to the methods described above exhibits superior properties than other graphene made by different methods. A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A disk for fabricating graphene, the disk comprising:
a thermoplastic polymer substrate with a reflection layer disposed on one side of the thermoplastic polymer substrate; and
a graphite oxide layer provided on the thermoplastic polymer substrate.

2. The disk of claim 1, further comprising:
a separation coating layer disposed between the thermoplastic polymer substrate and the graphite oxide layer.

3. The disk of claim 1, further comprising:
a protection layer disposed above the reflection layer.

4. The disk of claim 1, wherein the thermoplastic polymer substrate comprise a polycarbonate substrate.

5. A multilayered plate for fabricating graphene, the multilayered plate comprising:
a substrate;
a reflection layer formed on the substrate; and
a graphite oxide layer formed on the reflection layer.

6. The multilayered plate of claim 5, wherein the multilayered plate has a shape of a circular optical disk with a central hole.

7. The multilayered plate of claim 5, wherein the multilayered plate has a rectangular shape or a polygonal shape.

8. The multilayered plate of claim 6, wherein the substrate comprises a polycarbonate layer, and the substrate has a diameter of 11 cm to 13 cm with a planar upper surface.

9. The multilayered plate of claim 8, further comprising:
a protective layer disposed between the reflection layer and the graphite oxide layer; and
a separation coating layer disposed between the protective layer and the graphite oxide layer.

10. A method of manufacturing a disk for fabricating graphene, the method comprising:
obtaining a thermoplastic polymer substrate with a reflection layer disposed on one side thereof; and
applying a graphite oxide layer on the thermoplastic polymer substrate.

11. The method of claim 10, further comprising:
prior to the applying of the thin film of graphite oxide layer, applying a separation coating layer between the thermoplastic polymer substrate and the graphite oxide layer.

12. The method of claim 10, wherein the thermoplastic polymer substrate comprises a protection layer disposed above the reflection layer to protect the reflection layer.

13. The method of claim 10, wherein the thermoplastic polymer substrate comprises a polycarbonate substrate.

14. The method of claim 10, wherein the applying of the graphite oxide layer involves applying a graphite oxide solution formed by mixing graphite powder with a solvent.
